(19) United States
(12) Patent Application Publication
(10) Pub. No.: US 2024/0354957 A1
(43) Pub. Date: Oct. 24, 2024

(54) IMAGE PROCESSING DEVICE, IMAGE PROCESSING METHOD, AND COMPUTER PROGRAM

(71) Applicants: Canon Kabushiki Kaisha, Tokyo (JP); NATIONAL CANCER CENTER, Tokyo (JP); CANON MEDICAL SYSTEMS CORPORATION, Tochigi (JP)

(72) Inventors: Fumihiko NAKATANI, Chuo-ku (JP); Kazuhiro MIYASA, Narashino (JP)

(73) Assignees: Canon Kabushiki Kaisha, Tokyo (JP); NATIONAL CANCER CENTER, Tokyo (JP); CANON MEDICAL SYSTEMS CORPORATION, Tochigi (JP)

(21) Appl. No.: 18/637,665

(22) Filed: Apr. 17, 2024

(30) Foreign Application Priority Data
Apr. 18, 2023 (JP) 2023-068043

(51) Int. Cl. G06T 7/00; G06T 5/50; G06V 10/46

(52) U.S. Cl. CPC G06T 7/0016; G06T 5/50; G06V 10/46; G06T 2207/20224; G06T 2207/30012

(57) ABSTRACT

An image processing device according to an embodiment includes processing circuitry. The processing circuitry extracts the spinal canal from a subject region captured in a medical image. The processing circuitry extracts an abnormal region in the spinal canal. The processing circuitry sets the significance level in the abnormal region, according to a location in the spinal canal. The processing circuitry generates display data relating to the abnormal region on the basis of the significance level.

### CROSS-REFERENCE TO RELATED APPLICATIONS

This application is based upon and claims the benefit of priority from Japanese Patent Application No. 2023-068043, filed on Apr. 18, 2023; the entire contents of which are incorporated herein by reference.

### FIELD

Embodiments described herein relate generally to an image processing device, an image processing method, and a computer program.

### BACKGROUND

The spinal cord is a bundle of nerves located behind the spinal vertebrae, and the spinal canal is a tubular structure arranged to surround the spinal cord. When cancer invades into the spinal canal, the spinal cord may be compressed in the lumen of the spinal canal, and may lead to quadriplegia and trunk paralysis. Early detection of cancer invasion into the spinal canal is important, mainly to maintain the patient's Quality Of Life (QOL). However, in the present circumstances, spinal canal invasion is visually confirmed by doctors through a medical image, and the development of technologies to support the diagnosis has been desired.

For example, a technology has been developed to detect an abnormal region from an image to be diagnosed. However, when a candidate region of spinal canal invasion is simply detected and displayed as an abnormal region using such a technology, noise due to false detection of spinal canal invasion and clinically low-risk invasion may be displayed in an emphasized manner. As a result, clinically high-risk and significant invasion may become inconspicuous. In this example, Patent Literature 1 (Japanese Unexamined Patent Application Publication No. 2010-131127) discloses a technology that detects the tumor region in the lumen, that obtains information on the depth of the tumor region on the lumen wall, and that displays the depth information with an image of the lumen. However, although the technology disclosed in Patent Literature 1 can display the information on the depth of invasion into the lumen wall, that is, the vertebral region surrounding the spinal canal, the noise in the spinal canal and the low-risk invasion region may be emphasized.

### BRIEF DESCRIPTION OF THE DRAWINGS

FIG. 1 is a diagram illustrating an example of a configuration of an image processing system according to a first embodiment;

FIG. 2 is a flowchart illustrating an example of the overall processing procedure performed by an image processing device according to the first embodiment;

FIG. 3 is a schematic diagram illustrating the spinal canal and spinal canal invasion on the axial plane of the target image, in the first embodiment;

FIGS. 4A to 4D are schematic diagrams illustrating the significance level set in the spinal canal region on the axial plane of the target image, in the first embodiment;

FIGS. 5A and 5B are diagrams illustrating an example of image data (superimposed image) in which the invasion candidate region is superimposed on the target image, in the first embodiment;

FIG. 6 is a diagram illustrating a graph of index values (index value graph) representing the degree of invasion, calculated for the invasion candidate region, in the first embodiment;

FIG. 7 is a diagram illustrating a device configuration of an image processing system according to a second embodiment;

FIG. 8 is a flowchart illustrating an example of the overall processing procedure performed by an image processing device according to the second embodiment; and

FIG. 9 is a diagram illustrating an example of image data (superimposed image) in which the invasion candidate region extracted at step S2040 is superimposed on the target image, in the second embodiment.

### DETAILED DESCRIPTION

One problem to be solved by the embodiments disclosed in the present specification and the drawings is to reduce the noise in the spinal canal and the clinically low-risk invasion region from being emphasized, and to emphasize the clinically high-risk and significant invasion region. However, the problems to be solved by the embodiments disclosed in the present specification and the drawings are not limited to the problem described above. The problem corresponding to each effect of each configuration illustrated in the embodiments described below may be considered as another problem.

An image processing device according to an embodiment includes processing circuitry. The processing circuitry extracts the spinal canal from a subject region captured in a medical image. The processing circuitry extracts an abnormal region in the spinal canal. The processing circuitry sets the significance level in the abnormal region, according to a location in the spinal canal. The processing circuitry generates display data relating to the abnormal region on the basis of the significance level.

Hereinafter, embodiments of the present invention will be described in detail with reference to the accompanying drawings. Note that the following embodiments do not limit the present invention according to the claims, and not all combinations of features described in the present embodiments are essential to the solution of the present invention.

### First Embodiment

An image processing device according to a first embodiment will be described. The image processing device according to the present embodiment is a device that visualizes a candidate region of spinal canal invasion, in a subject region captured in a target image serving as an image to be processed. Specifically, for example, the image processing device extracts the spinal canal from a target image, and further extracts the invasion candidate region as a candidate region of spinal canal invasion that is an abnormal region in the spinal canal. The region of spinal canal invasion is a region where cancer bone metastasis has invaded the spinal canal. Then, the image processing device sets the clinically significant level representing how clinically significant the region is, with respect to the invasion candidate region, and controls to display an image in which the invasion candidate region is superimposed on the target image, and a graph of index values representing the degree of invasion, as display data.

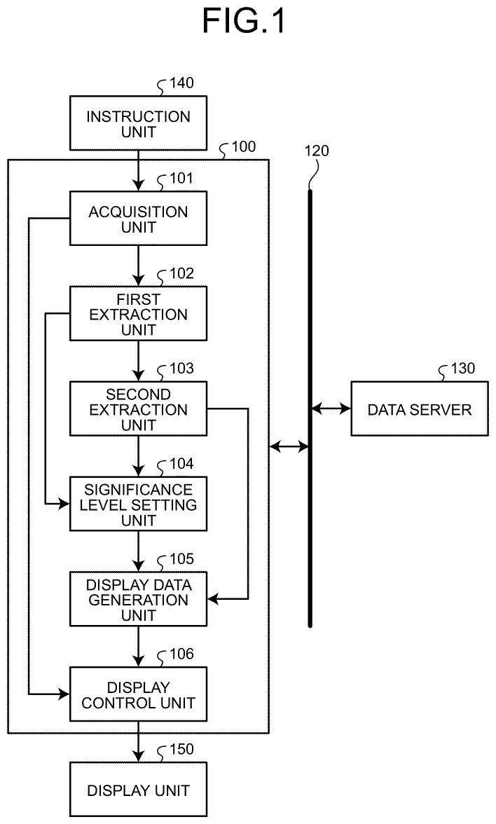

FIG. 1 is a diagram illustrating an example of a configuration of an image processing system according to the first embodiment. The present image processing system includes an image processing device 100 and a data server 130. The image processing device 100 is connected to the data server 130 via a network 120. The image processing device 100 according to the first embodiment is a device capable of extracting a candidate region of spinal canal invasion from a target image, and generating display data from the results.

The data server 130 stores a plurality of medical images (plurality of pieces of medical image data). For example, the data server 130 represents the Picture Archiving and Communication System (PACS) that receives medical images captured by a modality, and that stores and manages the received images through a network. In the following description, it is assumed that a plurality of three-dimensional tomographic images obtained by capturing images of a subject under different conditions (different modalities, imaging modes, dates and times, body positions, and the like) are stored in the data server 130, as medical images. In the present embodiment, the description is made assuming that the medical image is a three-dimensional tomographic image (three-dimensional medical image) captured by the X-ray CT apparatus.

In the present specification, the axis representing the direction from the right hand to the left hand of the subject is defined as the X-axis, the axis representing the direction from the front to the back of the subject is defined as the Y-axis, and the axis representing the direction from the head to the feet of the subject is defined as the Z-axis. Moreover, the XY cross-section is defined as the axial plane, the YZ cross-section is defined as the sagittal plane, and the ZX cross-section is defined as the coronal plane. That is, the X-axis direction is a direction orthogonal to the sagittal plane (hereafter, sagittal direction). Moreover, the Y-axis direction is a direction orthogonal to the coronal plane (hereafter, coronal direction). Furthermore, the Z-axis direction is a direction orthogonal to the axial plane (hereinafter, axial direction). In this process, in the case of a CT image formed as a set of two-dimensional tomographic images (slice images), the slice plane of the image represents the axial plane, and a direction orthogonal to the slice plane (hereinafter, slice direction) represents the axial direction. The way of setting the coordinate system is merely an example, and other definitions may also be used.

The medical image is a three-dimensional medical image (three-dimensional tomographic image) formed as a set of two-dimensional tomographic images. The modality for capturing three-dimensional tomographic images may be an MRI device, a three-dimensional ultrasonic imaging device, and the like. Then, it is assumed that the location and orientation of each of the two-dimensional tomographic images are converted into a standard coordinate system (coordinate system in space with reference to the subject), and is stored in the data server 130. In this process, the medical image expressed in the standard coordinate system is input to the image processing device 100 according to an instruction of a user who operates an instruction unit 140, which will be described below. The medical image may not be selected on the basis of the user instruction. For example, the image processing device 100 may automatically select the medical image on the basis of a predetermined rule.

The image processing device 100 is connected to the instruction unit 140 and a display unit 150. The instruction unit 140 includes devices such as a mouse, keyboard, touch panel, and the like. The instruction unit 140 receives various processing requests and various instructions from the user, and outputs the various processing requests and various instructions that have received to the image processing device 100.

The display unit 150 includes any device such as an LCD or CRT, and displays a medical image or the like for a doctor to interpret. Specifically, the display unit 150 displays a cross-sectional image of the target image obtained from the image processing device 100. Moreover, the display unit 150 displays display data generated by the image processing device 100.

The image processing device 100 includes a computer provided with a processor such as a Central Processing Unit (CPU) and memory. The processor reads a computer program stored in the memory, and executes the read computer program. The processor is an example of processing circuitry. When the processor that executes such a computer program is functionally illustrated, as illustrated in FIG. 1, the image processing device 100 includes an acquisition unit 101, a first extraction unit 102, a second extraction unit 103, a significance level setting unit 104, a display data generation unit 105, and a display control unit 106. In this manner, in the present embodiment, the image processing device 100 includes the components described above. For example, the significance level setting unit 104 is an example of a setting unit. Moreover, for example, the display data generation unit 105 is an example of a generation unit.

The image processing device 100 is a device that performs image processing by receiving a processing request of a user from the instruction unit 140, and outputting the processing results to the display unit 150. The image processing device 100 functions as a terminal device for interpretation operated by a user such as a doctor. Specifically, the image processing device 100 obtains a target image that is a medical image to be processed from the data server 130, on the basis of a user instruction through the instruction unit 140. Then, the image processing device 100 extracts an invasion candidate region from this image, generates display data, and outputs the generated display data to the display unit 150. Execution of processing need not be based on the user instruction, and for example, the processing may be automatically executed when a target image is input.

The acquisition unit 101 acquires information on the target image input to the image processing device 100. The first extraction unit 102 extracts the spinal canal region from the target image. The second extraction unit 103 extracts the invasion candidate region from the extracted spinal canal region. The significance level setting unit 104 sets the significance level in the spinal canal region and the invasion candidate region. The display data generation unit 105 generates display data on the invasion candidate region on the basis of the significance level. The display control unit 106 outputs the generated display data or the like to the display unit 150, and controls to display the display data on the display unit 150.

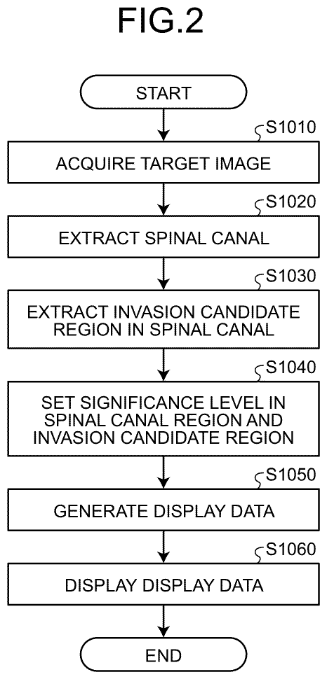

FIG. 2 is a flowchart illustrating an example of the overall processing procedure performed by the image processing device 100 according to the first embodiment.

### S1010 Acquire Target Image

At step S1010, the acquisition unit 101 acquires the target image specified by the user from the data server 130, through the instruction unit 140. Then, the acquisition unit 101 outputs the target image to the first extraction unit 102 and the display control unit 106.

### S1020 Extract Spinal Canal

At step S1020, the first extraction unit 102 performs a process of extracting the spinal canal region from the target image. For example, the first extraction unit 102 extracts a region of spinal canal (spinal canal region) from a region of a subject (subject region) captured in the target image. Then, the first extraction unit 102 outputs information on the spinal canal region to the second extraction unit 103 and the significance level setting unit 104.

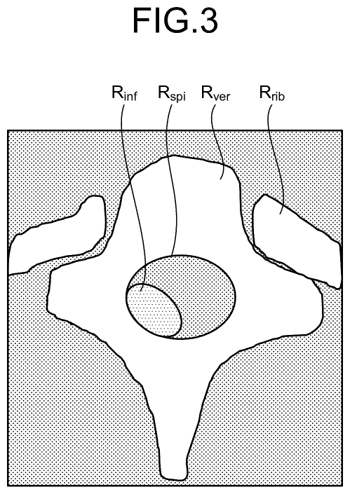

FIG. 3 is a schematic diagram illustrating the spinal canal and spinal canal invasion on the axial plane of the target image, in the first embodiment. In FIG. 3, Rᵥₑᵣ indicates the vertebral region, R_{rib} indicates the rib region, Rₛₚᵢ indicates the spinal canal region, and R_{inf} indicates a region of spinal canal invasion (spinal canal invasion region). In the present embodiment, the first extraction unit 102 extracts the spinal canal region Rₛₚᵢ using a known region extraction method. For example, the first extraction unit 102 extracts the spinal canal region by a morphological operation. When the target image is a CT image, as illustrated in FIG. 3, the spinal canal region Rₛₚᵢ is surrounded by the vertebral region Rᵥₑᵣ with a high pixel value, and the pixel value of the spinal canal region Rₛₚᵢ filled with soft tissues such as the spinal cord is lower than that of the vertebral region Rᵥₑᵣ. Therefore, the first extraction unit 102 first extracts a bone region including the vertebral region Rᵥₑᵣ with a high pixel value by predetermined threshold processing or the like, and then performs a Black-Top-Hat transformation that is a type of morphological operation, on the extracted bone region. Consequently, the first extraction unit 102 can extract the spinal canal region Rₛₚᵢ surrounded by the vertebral region Rᵥₑᵣ with a high pixel value.

The method of extracting the spinal canal region Rₛₚᵢ is not limited thereto. For example, an inference model that learned the spinal canal regions of a large number of cases may be constructed in advance, using the region extraction method by a known machine learning, and the first extraction unit 102 may extract the spinal canal region by inputting the target image into the inference model. A known region extraction method using machine learning includes a method such as Convolutional Neural Network (CNN).

### S1030 Extract Invasion Candidate Region in Spinal Canal

At step S1030, the second extraction unit 103 performs a process of extracting a candidate region of spinal canal invasion (invasion candidate region) Rₑₓₜ₁ from the spinal canal region extracted at step S1020. That is, at step S1030, the second extraction unit 103 extracts the invasion candidate region Rₑₓₜ₁ that is an abnormal region in the spinal canal. Then, the second extraction unit 103 outputs information on the invasion candidate region Rₑₓₜ₁ to the significance level setting unit 104 and the display data generation unit 105.

In the present embodiment, the second extraction unit 103 first obtains information on the likelihood of invasion indicating how likely each pixel in the spinal canal region is invaded, on the basis of the luminance information of the target image, and then extracts the invasion candidate region on the basis of the likelihood of invasion. It is assumed that the probability of invasion is increased with an increase in the value of likelihood of invasion of each pixel. At the present step, the second extraction unit 103 extracts the invasion candidate region Rₑₓₜ₁, by extracting the pixels in the spinal canal region having the value of likelihood of invasion of a certain threshold or higher. The process of obtaining the invasion candidate region from the distribution of the values of likelihood of invasion is not limited thereto, and any method that performs region extraction may be used in addition to the threshold processing. For example, the second extraction unit 103 may remove noise by morphological operation or the like, after performing the threshold processing. Moreover, the second extraction unit 103 may also use a segmentation technique such as the graph cut and the level set method. Furthermore, the process of obtaining the invasion candidate region from the distribution of values of likelihood of invasion may also be performed for each axial cross-sectional image, or on the entire target image. Still furthermore, the second extraction unit 103 may extract the invasion candidate region Rₑₓₜ₁ from a difference image between the target image and the past medical image of the subject (target image).

Hereinafter, a specific method of obtaining the likelihood of invasion on the basis of luminance information of the target image will be described. In FIG. 3, the spinal cord is located in the lumen of the spinal canal region Rₛₚᵢ, and certain pixel values are generally distributed in the normal tissues. On the other hand, if there is the spinal canal invasion region R_{inf}, the pixel values of the portion become higher than the pixel values of the other spinal canal. In other words, if the pixel value in the spinal canal is high, there is a high possibility that the portion is invaded. Therefore, the second extraction unit 103 can obtain the pixel value of each pixel in the spinal canal region Rₛₚᵢ as the value of likelihood of invasion. Moreover, the second extraction unit 103 may also obtain the likelihood of invasion, by defining any conversion function f that converts a pixel value I of each pixel in the spinal canal region Rₛₚᵢ into a value d of likelihood of invasion, using d=f (I). The value of likelihood of invasion is preferably normalized within a predetermined range (for example, between 0 and 1).

Moreover, the method of obtaining the likelihood of invasion is not limited thereto. For example, the acquisition unit 101 may obtain the past image of the patient who is the same person in the target image that is captured in the past from the data server 130, and the second extraction unit 103 may acquire the likelihood of invasion by comparing the target image with the past image. More specifically, the second extraction unit 103 first associates the location in the target image with that of the past image using a known alignment process, and then performs a difference process in which the past image is subtracted from the target image. Consequently, when the spinal canal invasion is not present in the past image, or when the degree of invasion in the past image is smaller than that of the target image, a high difference values appear in the invasion region. In this manner, when the difference value in the spinal canal is high, there is a high possibility of invasion. Hence, the second extraction unit 103 can obtain the difference value of each pixel in the spinal canal region, after subtracting the past image from the target image, as the likelihood of invasion. For example, a known alignment technique includes a method using an affine transformation, Free Form Deformation (FFD), Demons algorithm, Large Deformation Diffeomorphic Metric Mapping (LDDMM), and the like.

Moreover, for example, as another method of obtaining the likelihood of invasion, the second extraction unit 103 may also use a known machine learning method that performs region extraction. Specifically, an inference model that learned the invasion regions of a large number of cases may be constructed in advance, and the second extraction unit 103 may use the output value of each pixel in the spinal canal obtained by inputting the target image into the inference model, as the value of likelihood of invasion. The method similar to that described at step S1020 may be used for the region extraction method using known machine learning. In general, the output value of each pixel in an inference model such as a CNN is a value between 0 and 1. The possibility of being a region to be extracted is increased with an increase in the value. Therefore, the second extraction unit 103 can obtain the output value of each pixel in the machine-learned inference model that has learned the invasion region as the likelihood of invasion.

### S1040 Set Significance Level in Spinal Canal Region and Invasion Candidate Region

At step S1040, the significance level setting unit 104 sets the clinically significant level (hereinafter, referred to as significance level) representing how clinically significant the location is, with respect to each pixel in the spinal canal region Rₛₚᵢ and the invasion candidate region Rₑₓₜ₁, on the basis of location information of the pixel in the spinal canal. That is, the significance level setting unit 104 sets the clinically significant level for each of the pixels representing the invasion candidate region Rₑₓₜ₁, according to the location in the spinal canal. Then, the significance level setting unit 104 outputs information on the significance level, to the display data generation unit.

A method of setting the significance level will now be described. The spinal cord compression level is higher when the spinal canal invasion reaches the inner region close to the center of the spinal canal than when the spinal canal invasion remains in the outer region close to the contour of the spinal canal. Hence, the risk of quadriplegia and trunk paralysis is increased, and the location is clinically significant. Therefore, in the present embodiment, the significance level setting unit 104 sets the significance level in the spinal canal such that the value of the significance level is greater in the inner region close to the center, than in the outer region close to the contour. Moreover, the degree of clinical risk due to a difference in location of invasion, changes depending on the location in the cross section intersecting the running direction of the spinal canal. Therefore, in the present embodiment, the significance level setting unit 104 sets the significance level in the units of cross section intersecting the running direction of the spinal canal. More specifically, since the running direction of the spinal canal is generally along the Z direction of the target image, the significance level setting unit 104 uses the axial plane of the target image that is a cross section orthogonal to the Z direction, as the cross section intersecting the running direction of the spinal canal, and sets the significance level for each axial plane of the target image. The cross section intersecting the running direction of the spinal canal is not limited thereto. For example, the significance level setting unit 104 may extract the core line of the spinal canal, and use the cross section intersecting the core line. Moreover, the following cross sections may also be used. For example, the significance level setting unit 104 first generates a Curved Planner Reconstruction (CPR) image that is an image obtained by cutting out the curved cross section along the core line of the spinal canal, from the peripheral region including the spinal canal in the target image, and is converted into a plane such that the core line is straightened. Then, the significance level setting unit 104 may use the cross section orthogonal to the generated CPR image. Hereinafter, a specific example of a method of setting the significance level will be described.

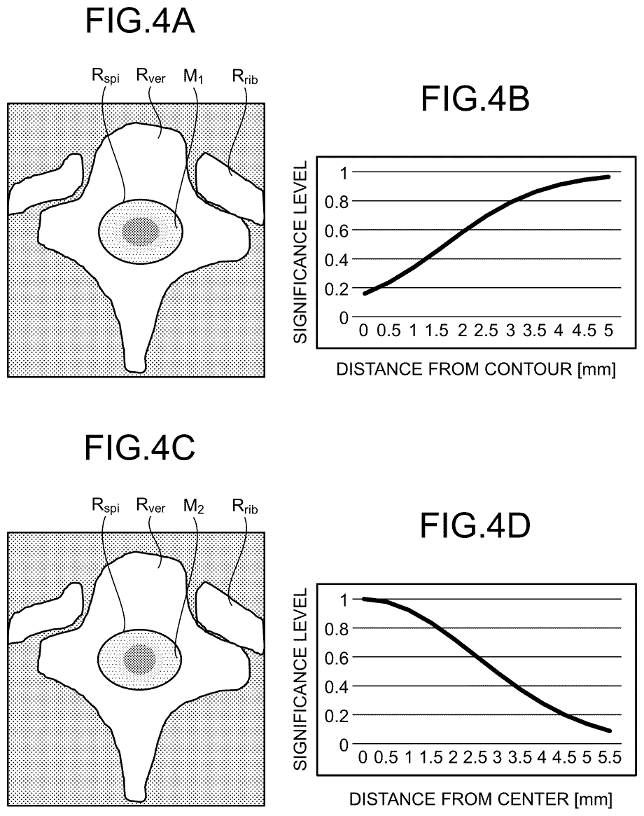

FIGS. 4A to 4D are schematic diagrams illustrating the significance level set in the spinal canal region Rₛₚᵢ on the axial plane of the target image, in the first embodiment. FIG. 4A is a diagram illustrating an example in which the significance level is set in the spinal canal region Rₛₚᵢ on the basis of the distance from the contour of the spinal canal on the axial plane. Moreover, FIG. 4B is a diagram illustrating an example of functions for calculating the significance level on the basis of the distance from the contour of the spinal canal, corresponding to FIG. 4A. Hereafter, the function for calculating the significance level is referred to as a significance level calculation function. The significance level setting unit 104 calculates the significance level using the significance level calculation function. In FIGS. 4A and 4B, Rᵥₑᵣ, R_{rib}, and Rₛₚᵢ represent the same as those in FIG. 3. Moreover, M₁ represents a significance level map when the significance level is set in the spinal canal region Rₛₚᵢ on the basis of the distance from the contour of the spinal canal on the axial plane. In this process, it is assumed that the significance level is a positive real number, and the maximum value of which is the value 1.0.

In the significance level map M₁ in FIG. 4A that is an example of the significance level, the color of the significance level map is made darker, that is, the significance level is increased, toward the center of the spinal canal with reference to the contour of the spinal canal on the axial plane of the target image. Consequently, it is possible to set the significance level in terms of how far the invasion has progressed to the inside from the end portion of the spinal canal. The characteristics of the significance level map M₁ is such that the contour shape of the spinal canal is reflected in the gradation of significance levels. The significance level calculation function in FIG. 4B for calculating the significance level map M₁ is represented by the following equation (1) of sigmoid function.

$$f ( x ) = \frac{1}{1 + {e}^{- a ( x - β )}} \qquad ( 1 )$$

In Equation (1), x represents the distance from the contour of the spinal canal, α represents the gradient of the function, and β represents the center position of the function. In this example, values of α=1.0 and β=1.5 are used, for example. In this case, at the location where the distance from the contour of the spinal canal is 0.0 mm (location on the contour), a value low in significance level but a value greater than zero (value around 0.2) is taken, and at the location where the distance from the contour is 5.0 mm, a value the significance level of which is close to the maximum value 1.0 is taken. By setting the significance level to a small value but a value greater than zero at the location on the contour, the significance level setting unit 104 can set, to a region in the vicinity of the contour, the significance level indicating that the clinical risk is not significant but there is a low degree of risk if there is invasion. Moreover, by setting the significance level to a value close to the maximum value 1.0 at the location where the distance from the contour is 5.0 mm, the following effects can be obtained. That is, the significance level setting unit 104 can set the significance level indicating that there is a clinically significant risk if there is invasion, with respect to the region (region where the distance from the center is within about 2.5 mm) close to the center of the spinal canal the normal diameter of which is around 15.0 mm (radius of 7.5 mm). The significance level calculation function based on the distance from the contour of the spinal canal is not limited thereto. The significance level calculation function may be any function that takes the maximum value 1 around the center of the spinal canal and that takes a small value but a value greater than zero in the vicinity of the contour, and that changes smoothly between the two values. For example, a Gaussian function that takes the maximum value 1 around the center of the spinal canal, and that attenuates smoothly with a reduction in distance may be used. In the present embodiment, the method defined in FIGS. 4A and 4B described above is used as the method for calculating the significance level.

The distance from the contour of the spinal canal may be an approximate value. For example, the significance level setting unit 104 may approximate the contour of the spinal canal to an oval shape, and use the distance from the oval shape. Consequently, because it is possible to easily calculate the distance from the oval center to each location in the oval, the distance can be calculated at high speed. Moreover, the distance from the contour of the spinal canal may be the distance from the nearest contour in a three-dimensional manner.

Furthermore, the following method may be used as the method for calculating the significance level. FIG. 4C is a diagram illustrating an example of setting the significance level in the spinal canal region Rₛₚᵢ on the basis of the distance from the center of the spinal canal on the axial plane. M₂ represents a significance level map that is another example of the significance level when the significance level is set in the spinal canal region Rₛₚᵢ on the basis of the distance from the center of the spinal canal on the axial plane. In this process, it is assumed that the significance level is a positive real number, and the maximum value of which is the value 1.0. Moreover, FIG. 4D is a diagram illustrating an example of functions for calculating the significance level on the basis of the distance from the center of the spinal canal, corresponding to FIG. 4C. In the significance level map M₂ in FIG. 4C, the color of the significance level map is made lighter, that is, the significance level is reduced, toward the contour of the spinal canal with reference to the center of the spinal canal on the axial plane of the target image. Consequently, the significance level setting unit 104 can set the significance level in terms of how close the invasion is from the center of the spinal canal. The characteristics of the significance level map M₂ is such that the gradation of significance levels spreads in a concentric manner, irrelevant to the contour shape of the spinal canal. The significance level calculation function in FIG. 4D for calculating the significance level map M₂ is represented by the following equation (2) of Gaussian function.

$$f ( x ) = exp ( - \frac{{( x - μ )}^{2}}{2 {σ}^{2}} ) \qquad ( 2 )$$

In equation (2), x represents the distance from the center of the spinal canal, μ represents the center position of the function, and σ represents the spreading degree of the function. In this example, values of μ=0.0 and σ=2.5 are used, for example. In this case, at the location where the distance from the center of the spinal canal is 0.0 mm (center position of the spinal canal), the maximum value 1.0 is taken, and at the location where the distance from the center is 5.0 mm, a value low in significance level but a value greater than zero (value around 0.1) is taken. By setting the significance level to the maximum value 1.0 at the center position, the significance level setting unit 104 can set the significance level indicating that there is a clinically significant risk if there is invasion, with respect to the center position of the spinal canal. Moreover, by setting the significance level to a small value but is a value greater than zero with respect to the region separated from the center to some extent, the significance level setting unit 104 can set the significance level indicating that the clinical risk is not significant but there is a low degree of risk if there is invasion. The function for calculating the significance level on the basis of the distance from the center of the spinal canal is not limited thereto. Any function that takes the maximum value 1 at the center of the spinal canal, and that takes a small value but a value greater zero in the region separated from the center, and that changes smoothly between the two values may also be used. For example, a sigmoid function that takes the maximum value 1 at the center of the spinal canal and that attenuates smoothly with an increase in the distance may be used.

The distance from the center of the spinal canal may be an approximate value. For example, the significance level setting unit 104 may approximate the running shape of the core line including the center position of the spinal canal to an approximate line (such as a broken line and a spline curve: hereinafter, referred to as an approximate line), and the distance from the center of the spinal canal may be the distance from this approximate line. Moreover, the distance from the center of the spinal canal may be the distance from the nearest core line in a three-dimensional manner.

Furthermore, the method of calculating the significance level is not limited to the method described above. Any method in which the value at the center part of the spinal canal becomes greater than that of the side edge part may be used.

In the present embodiment, the significance level setting unit 104 sets the significance level for each of the pixels corresponding to the spinal canal region Rₛₚᵢ in the target image. More specifically, the significance level setting unit 104 can assign the significance level to each pixel, by performing calculation using the significance level calculation function described above for each location of the pixel corresponding to the spinal canal region Rₛₚᵢ. Moreover, because the invasion candidate region Rₑₓₜ₁ in the spinal canal is a region included in the spinal canal, by setting the significance level for the pixel corresponding to the spinal canal region Rₛₚᵢ, the significance level is automatically set in the invasion candidate region Rₑₓₜ₁. In other words, at the present step, it is not necessary to obtain information on the invasion candidate region Rₑₓₜ₁, but only information on the spinal canal region Rₛₚᵢ may be obtained. On the other hand, the significance level setting unit 104 may use the acquired information on the invasion candidate region Rₑₓₜ₁, and set the significance level only for the pixel corresponding to the invasion candidate region Rₑₓₜ₁. Consequently, by narrowing the range where the significance level is calculated, the significance level can be calculated at high speed. This method can be applied when the display data using the significance level of the entire spinal canal region Rₛₚᵢ (more specifically, a graph of index values representing the degree of invasion generated by weighting the area of the spinal canal region Rₛₚᵢ by the significance level) is not generated at step S1050, which will be described below.

### S1050 Generate Display Data

At step S1050, the display data generation unit 105 generates display data on the invasion candidate region Rₑₓₜ₁ on the basis of the significance level. That is, the display data generation unit 105 generates display data on the invasion candidate region Rₑₓₜ₁ on the basis of the significance level. Then, the display data generation unit 105 outputs the display data to the display control unit 106. In the present embodiment, the display data generation unit 105 generates two types of display data.

As an example of the display data, the display data generation unit 105 generates image data in which the invasion candidate region Rₑₓₜ₁ extracted at step S1030 is superimposed on the target image (hereinafter, referred to as a superimposed image).

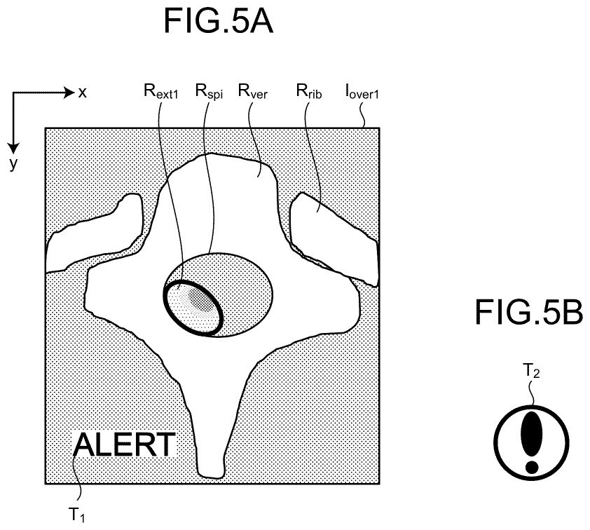

FIGS. 5A and 5B are diagrams illustrating an example of image data (superimposed image) in which the invasion candidate region Rₑₓₜ₁ is superimposed on the target image, in the first embodiment. In FIG. 5A, Iₒᵥₑᵣ₁ represents the superimposed image. Moreover, Rᵥₑᵣ, R_{rib}, and Rₛₚᵢ represent the same as those in FIG. 3. Furthermore, Rₑₓₜ₁ represents the invasion candidate region. The display color of the invasion candidate region Rₑₓₜ₁ is changed on the basis of the significance level. Still furthermore, T₁ is a warning message superimposed on the image when the invasion candidate region Rₑₓₜ₁ is on the axial plane.

At the present step, the display data generation unit 105 applies display color to the invasion candidate region Rₑₓₜ₁ extracted at step S1030. As the display color, it is preferable to display color that can distinguish the luminance values in the surrounding spinal canal. In the example in FIG. 5A, the invasion candidate region Rₑₓₜ₁ is colored such that the invasion candidate region Rₑₓₜ₁ can be distinguished from the surrounding region in the spinal canal. The invasion candidate region Rₑₓₜ₁ is a region where a region corresponding to the spinal canal invasion region R_{inf} in FIG. 3 is extracted as a candidate for the spinal canal invasion. In this manner, by allowing the user to confirm the invasion candidate region Rₑₓₜ₁, it is possible to support the user to detect the presence of spinal canal invasion.

Moreover, at the present step, the display data generation unit 105 changes the display color of each pixel in the invasion candidate region Rₑₓₜ₁ on the basis of the significance level set at step S1040. More specifically, for example, the display data generation unit 105 makes the color darker with an increase in the significance level. In this manner, by coloring the invasion candidate region Rₑₓₜ₁ on the target image, the user can easily find the invasion candidate. In addition, by making the color of a region close to the center of the spinal canal on the upper right of the invasion candidate region Rₑₓₜ₁ darker, the user can easily recognize that the region is determined as a clinically high-risk and significant region.

On the other hand, by making the color of a region close to the contour of the spinal canal on the lower left of the invasion candidate region Rₑₓₜ₁ lighter, the user can easily recognize that the region is determined as a clinically low-risk and insignificant region. That is, by changing the display color of the invasion candidate region Rₑₓₜ₁ on the basis of the significance level, the user can easily recognize how clinically significant the extracted invasion candidate region Rₑₓₜ₁ is. In this manner, according to the present embodiment, it is possible to emphatically display the clinically significant spinal canal invasion, and reduce the clinically insignificant spinal canal invasion and noise from being emphasized.

The method of changing the display color according to the significance level is not limited thereto. The display data generation unit 105 may also change colors between two different colors (for example, blue and red) in gradation according to the significance level. Moreover, the display data generation unit 105 may also change colors in gradation, by associating the significance level with a color table of three or more colors defined in advance. Furthermore, the display data generation unit 105 may divide the significance level into a plurality of stages, assign different textures according to the stage of significance level, and superimpose the textures on the image data. Still furthermore, the display data generation unit 105 may also change the display method of a message T₁ according to the distribution of significance levels in the invasion candidate region Rₑₓₜ₁. For example, the display data generation unit 105 may emphatically display the message T₁, by increasing the size of the message T₁ or by thickening and making the message T₁ darker, with an increase in the sum total of the significance values in the invasion candidate region Rₑₓₜ₁. Still furthermore, the message T₁ does not have to be a character string, but may also be an icon such as T₂ illustrated in FIG. 5B instead of the character string. Still furthermore, the superimposed image Iₒᵥₑᵣ₁ does not have to include the message T₁. The superimposed image Iₒᵥₑᵣ₁ does not have to be an image in which the invasion candidate region Rₑₓₜ₁ is colored and superimposed on the target image. For example, the superimposed image Iₒᵥₑᵣ₁ may also be a difference image that stores the difference value obtained by subtracting the past image of the same patient from the target image, as described at step S1030.

As described above, the display data is image data in which the display color of each pixel corresponding to the invasion candidate region Rₑₓₜ₁ is changed on the basis of the significance level. In this example, the significance level is set on the basis of the distance from the contour of the spinal canal. For example, the significance level is set higher as the distance from the contour of the spinal canal increases.

Moreover, as an example of the display data, the display data generation unit 105 generates a graph of index values (hereinafter, referred to as index value graph) representing the degree of invasion with respect to the invasion candidate region Rₑₓₜ₁ extracted at step S1030.

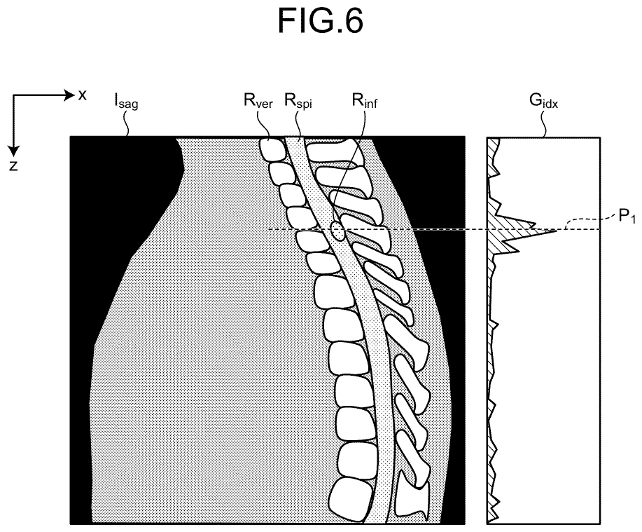

FIG. 6 is a diagram illustrating a graph of index values (index value graph) representing the degree of invasion, calculated for the invasion candidate region Rₑₓₜ₁, in the first embodiment. In FIG. 6, I_{sag} represents an image on the sagittal plane in the target image. In the image I_{sag}, River, Rₛₚᵢ, and R_{inf} represent the same as those in FIG. 3. G_{idx} represents the index value graph, and is a graph in which the index values representing the degree of invasion into the spinal canal are plotted on each axial plane of the target image, along the Z-axis of the image I_{sag}.

At the present step, as the index value representing the degree of invasion, the display data generation unit 105 calculates a weighted area weighted to an area of the region, relative to the spinal canal region Rₛₚᵢ and the invasion candidate region Rₑₓₜ₁, for each axial plane on the target image, on the basis of the significance level set for each pixel in each region at step S1040. Then, the display data generation unit 105 calculates the ratio of the weighted area (weighted ratio) of the invasion candidate region Rₑₓₜ₁ with respect to the weighted area of the spinal canal region Rₛₚᵢ, as an index value representing the degree of invasion. In other words, the display data generation unit 105 calculates an index value V_{idx} using the following equation (3).

$${v}_{idx} = \frac{{\sum }_{j = 1}^{{N}_{ext}} {w}_{j}}{{\sum }_{i = 1}^{{N}_{spi}} {w}_{i}} \qquad ( 3 )$$

In equation (3), i represents the number of the pixel belonging to the spinal canal region Rₛₚᵢ, and j represents the number of the pixel belonging to the invasion candidate region Rₑₓₜ₁. Moreover, w₁ represents the significance level of the i-th pixel in the spinal canal region Rₛₚᵢ, and wⱼ represents the significance level of the j-th pixel in the invasion candidate region Rₑₓₜ₁. Then, Nₛₚᵢ represents the number of pixels in the spinal canal region Rₛₚᵢ, and Nₑₓₜ represents the number of pixels in the invasion candidate region Rₑₓₜ₁. In equation (3), the minimum value is taken at index value V_{idx}=0.0, when the invasion candidate region Rₑₓₜ₁ is not present, that is, at Nₑₓₜ=0. On the other hand, the maximum value is taken at 1.0, when the invasion candidate region Rₑₓₜ₁ coincides with the spinal canal region Rₛₚᵢ (when the invasion candidate region Rₑₓₜ₁ occupies the entire spinal canal region Rₛₚᵢ), that is, at Nₑₓₜ=Nₛₚᵢ. According to equation (3), the pixel around the center of the spinal canal with a high significance value contributes more to the weighted area, while the pixel around the contour of the spinal canal with a low significance value contributes less to the weighted area. Consequently, the index value V_{idx} takes a large value when the invasion candidate region Rₑₓₜ₁ is distributed around the center of the spinal canal, and the index value V_{idx} takes a small value when the invasion candidate region Rₑₓₜ₁ is distributed only around the contour of the spinal canal.

In FIG. 6, P₁ is the graph position on the index value graph G_{idx} corresponding to the spinal canal invasion region R_{inf} on the image I_{sag}. It is apparent that the index value V_{idx} at P₁ is higher than the surroundings. For example, in FIG. 3, the spinal canal invasion region R_{inf} is distributed to the location close to the center of the spinal canal. Hence, there are many regions with a high significance level in the invasion candidate region Rₑₓₜ₁. Consequently, the index value V_{idx} is large. On the other hand, there is no spinal canal invasion that distributes to the location close to the center of the spinal canal in the other regions of the spinal canal, and a region with a high significance level is not included in the extracted invasion candidate region Rₑₓₜ₁. Hence, the index value V_{idx} is small. For this reason, the index value V_{idx} at P₁ is higher than the surroundings. In this manner, by calculating and graphically illustrating the index values representing the degree of invasion according to the significance level, it is possible to emphatically display the clinically significant spinal canal invasion, and reduce the clinically insignificant spinal canal invasion and noise from being emphasized.

In this manner, the index value graph G_{idx} is data indicating the index value V_{idx} that represents the degree of abnormality relating to the invasion candidate region Rₑₓₜ₁. Moreover, the index value V_{idx} is a value relating to the weighted area in the invasion candidate region Rₑₓₜ₁, in which the significance level of each pixel representing the invasion candidate region Rₑₓₜ₁ is used as a weight. Furthermore, the index value V_{idx} is the ratio of the weighted area in the invasion candidate region Rₑₓₜ₁ with respect to the weighted area in the region of the spinal canal, in which the significance level of each pixel representing the region of spinal canal is used as a weight. Still furthermore, the index value graph G_{idx} is a graph in which the index value V_{idx} calculated for each cross section intersecting the running direction of the spinal canal in the target image is plotted along the running direction.

Still furthermore, in the significance level calculation function at step S1040, as the significance level on the contour (location where the distance from the contour=0) of the spinal canal, a small value but a value greater than zero (around 0.2) is taken. Therefore, when the invasion candidate region Rₑₓₜ₁ is present only around the contour, the index value V_{idx} that is a small value but has a value of a certain magnitude is calculated. As a result, the following effects can be obtained. If the significance level on the contour is calculated as zero, the significance level takes a value extremely close to zero when the invasion candidate region Rₑₓₜ₁ is only present around the contour. Hence, the index value V_{idx} takes a value extremely close to zero. Thus, even if the early spinal canal invasion is only present around the contour, the index value becomes a value close to zero and hardly appears on the graph. Hence, the user may overlook the invasion. However, by using the method described above, it is possible to prevent the user from overlooking the invasion, because the index value corresponding to the early spinal canal invasion that is present only around the contour of the spinal canal appears on the graph.

At the present step, the value (weighted ratio) obtained by dividing the weighted area of the invasion candidate region Rₑₓₜ₁ by the weighted area of the spinal canal region Rₛₚᵢ is used as the index value V_{idx} representing the degree of invasion. However, the index value V_{idx} is not limited thereto. For example, the display data generation unit 105 may directly use the weighted area of the invasion candidate region Rₑₓₜ₁ as the index value Vide, and graphically illustrate the value as an index value graph.

At the present step, the display data generation unit 105 generates the superimposed image Iₒᵥₑᵣ₁ and the index value graph G_{idx} as display data. However, the display data generation unit 105 may generate only one of the superimposed image Iₒᵥₑᵣ₁ and the index value graph G_{idx}.

### S1060 Display Display Data

At step S1060, the display control unit 106 controls to display the display data obtained from the display data generation unit 105 and the target image obtained from the acquisition unit 101, on the display unit 150. Moreover, the display control unit 106 controls to display the cross-sectional image of the target image and the cross-sectional image of the superimposed image Iₒᵥₑᵣ₁ in the display data on the display unit 150 in an interlocking manner. Furthermore, the display control unit 106 controls to display the index value graph G_{idx} on the target image and the superimposed image Iₒᵥₑᵣ₁, and the display unit 150, in an interlocking manner. More specifically, if the cross-sectional image on which the target image and the superimposed image Iₒᵥₑᵣ₁ are displayed, is the axial plane, the display control unit 106 displays the corresponding location on the target image in the Z direction with a line, an arrow, or the like, on the index value graph G_{idx}. The display data to be displayed may be the superimposed image Iₒᵥₑᵣ₁ and the index value graph G_{idx}, or one of the superimposed image Iₒᵥₑᵣ₁ and the index value graph G_{idx}.

In FIG. 6, the display control unit 106 displays the index value graph representing the degree of spinal canal invasion on the display unit 150 with the superimposed image. However, the display control unit 106 may also display the index value graph representing the degree of extraosseous mass on the display unit 150 with the superimposed image in the same manner. Moreover, with respect to the superimposed image, the display control unit 106 may display the index value graph representing the degree of spinal canal invasion and the index value graph representing the degree of extraosseous mass on the display unit 150 in a comparable manner. For example, the display control unit 106 may display an image in which both index value graphs are further superimposed on the superimposed image, or may display both index value graphs and the superimposed image side by side. Alternatively, the display control unit 106 may display both index value graphs in a switchable manner according to the user instruction.

In this example, the index value graph representing the degree of extraosseous mass is a graph in which the index values representing the degree of increase in the mass around the vertebrae are plotted on each axial plane of the target image, along the Z-axis of the image I_{sag}. The index value graph representing the degree of extraosseous mass is generated by the display data generation unit 105. The index value is a value obtained by extracting the mass region from the pixel values of the current image or the difference image around the vertebrae using the threshold processing or machine learning, and dividing the area of the mass region by the area around the vertebrae having a predetermined width. When spinal canal invasion occurs, an extraosseous mass often occurs around the vertebrae at the same time. Hence, by causing the display data generation unit 105 to visualize and graphically illustrate the extraosseous mass, and by causing the display control unit 106 to display both index value graphs on the display unit 150, the user can observe both spinal canal invasion and extraosseous mass. Hence, it is possible to prevent the user from overlooking the invasion.

The display control unit 106 may also store the generated display data in a storage unit, which is not illustrated, or the data server 130 in association with the target image. Consequently, any other medical image viewer can display the target image and the display data. Moreover, when the user wishes to obtain the display data again after the processing by the present image processing device 100 is finished, the acquisition unit 101 can easily obtain the display data, by reading the stored display data. Furthermore, when the generated display data is stored, the display control unit 106 may not perform the display process of the display data at step S1060. Still furthermore, the display control unit 106 may not necessarily store the generated display data in the storage unit, which is not illustrated. The display data to be stored may be the superimposed image Iₒᵥₑᵣ₁ and the index value graph G_{idx}, Or may be one of the superimposed image Iₒᵥₑᵣ₁ and the index value graph G_{idx}.

Thus, the processing by the image processing device 100 according to the first embodiment is performed.

According to the first embodiment, the image processing device 100 sets the clinically significant level indicating how clinically significant the invasion candidate region Rₑₓₜ₁ is, with respect to the invasion candidate region Rₑₓₜ₁ extracted from the target image, and then displays an image in which the invasion candidate region Rₑₓₜ₁ is superimposed on the target image and the graph of index values representing the degree of invasion, as display data. Consequently, the image processing device 100 can emphatically display the clinically significant spinal canal invasion, and reduce the clinically insignificant spinal canal invasion and noise in the spinal canal from being emphasized. Thus, the image processing device 100 can reduce the noise in the spinal canal and the clinically low-risk invasion region from being emphasized, and emphasize the clinically high-risk and significant invasion region.

### Second Embodiment

Next, an image processing device 200 according to a second embodiment will be described. In the first embodiment, the image processing device 100 generates the display data, by first extracting the invasion candidate region Rₑₓₜ₁ in the spinal canal, and then by weighting the invasion candidate region Rₑₓₜ₁ on the basis of the significance level. On the other hand, in the second embodiment, the image processing device 200 extracts the invasion candidate region by weighting the likelihood of invasion at each location in the spinal canal with the significance level, when extracting the invasion candidate region. Then, the image processing device 200 generates the display data on the basis of the results. Hereinafter, the image processing device 200 according to the second embodiment will be described. In the description of the second embodiment, the same reference numerals are assigned to the same components as those in the image processing device 100 according to the first embodiment described above, and the description may be omitted.

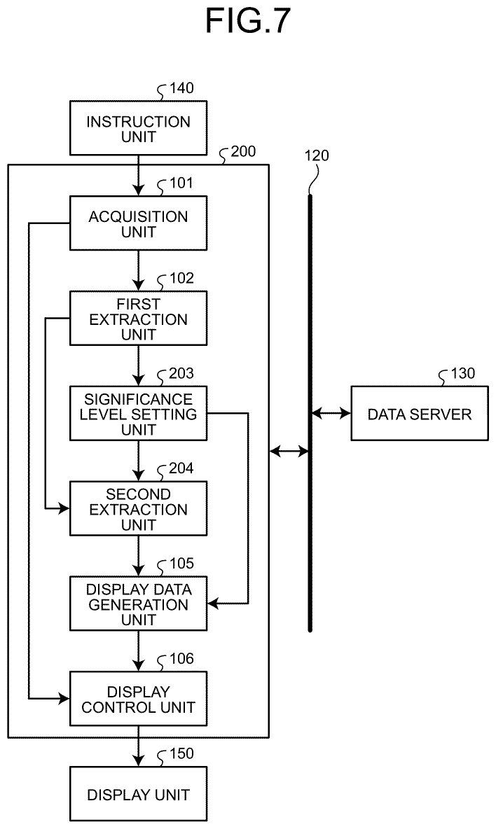

FIG. 7 is a diagram illustrating an example of a configuration of an image processing system according to the second embodiment. The present image processing system includes the image processing device 200, and because the connection relation with the network and the role of processing are the same as those of the image processing device 100 of the first embodiment, the description will be omitted. Moreover, the configuration of the image processing device 200 is the same as that of the image processing device 100 except that the arrangement of the second extraction unit 103 and the significance level setting unit 104 is reversed, and the second extraction unit 103 and the significance level setting unit 104 are changed to a significance level setting unit 203 and a second extraction unit 204. Hence, the description will be omitted. Hereinafter, different portions between the second embodiment and the first embodiment will be mainly described. The significance level setting unit 203 sets the significance level in the extracted spinal canal region Rₛₚᵢ. On the basis of the significance level, the second extraction unit 204 extracts the invasion candidate region from the extracted spinal canal region Rₛₚᵢ. For example, the significance level setting unit 203 is an example of a setting unit.

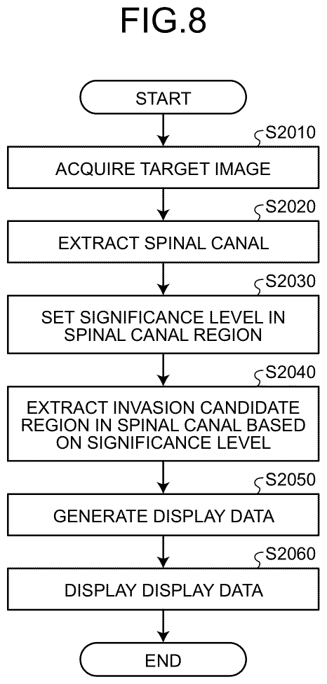

FIG. 8 is a flowchart illustrating an example of the overall processing procedure performed by the image processing device 200 according to the second embodiment. Because steps S2010 to S2020 and S2050 to S2060 in FIG. 8 in FIG. 8 are the same as steps S1010 to S1020 and S1050 to S1060 in the first embodiment, the description will be omitted. Hereinafter, different portions from the first embodiment in the flowchart in FIG. 8 will be mainly described.

### S2030 Set Significance Level in Spinal Canal Region

At step S2030, the significance level setting unit 203 sets the clinically significant level (hereinafter, referred to as significance level) indicating how clinically significant the location of the pixel is, with respect to each pixel in the spinal canal region Rₛₚᵢ. That is, the significance level setting unit 203 sets the clinically significant level for each pixel in the spinal canal, according to the location in the spinal canal. Then, the significance level setting unit 203 outputs information on the significance level, to the display data generation unit 105. Because the present step is a process simply excluding the process of setting the significance level in the invasion candidate region Rₑₓₜ₁, from the process at step S1040 according to the first embodiment, the detailed description will be omitted.

### S2040 Extract Invasion Candidate Region in Spinal Canal Based on Significance Level

At step S2040, the second extraction unit 204 performs a process of extracting the invasion candidate region from the spinal canal region extracted at S2020 as an abnormal region, on the basis of the significance level set at step S2030. That is, the second extraction unit 204 extracts the invasion candidate region in the spinal canal on the basis of the significance level. Then, the second extraction unit 204 outputs information on the invasion candidate region to the display data generation unit 105.

In the present embodiment, the image processing device 200 first obtains information on the likelihood of invasion indicating how likely each pixel in the spinal canal region is invaded, on the basis of the luminance information of the target image. Then, the image processing device 200 extracts the invasion candidate region after weighting the likelihood of invasion with the significance level set at step S2030. Because the method of obtaining the likelihood of invasion is the same as that at step S1030 in the first embodiment, the description will be omitted.

Hereinafter, a method of extracting the invasion candidate region after weighting the likelihood of invasion with the significance level, performed by the image processing device 200 will be described. First, the second extraction unit 204 calculates the likelihood of invasion weighted with the significance level, by multiplying the significance value set for each pixel in the spinal canal region Rₛₚᵢ at step S2030, by the likelihood of invasion set for each pixel in the spinal canal region Rₛₚᵢ. Then, the second extraction unit 204 extracts the invasion candidate region, by extracting the pixel in the spinal canal region Rₛₚᵢ that has the weighted value of likelihood of invasion of a predetermined threshold or more. In this manner, when the second extraction unit 204 weights the likelihood of invasion obtained on the basis of the luminance information of the target image, on the basis of the clinically significant level that cannot be obtained from the luminance information, the following effects can be obtained. That is, it is possible to extract the clinically significant region as the invasion candidate region, and remove the clinically insignificant region from the invasion candidate region. The method of extracting the invasion candidate region from the distribution of the weighted likelihood of invasion is not limited to the threshold processing, and other processes may also be used as the process at step S1030.

### S2050 Generate Display Data

At step S2050, the display data generation unit 105 generates display data on the invasion candidate region. Then, the display data generation unit 105 outputs the display data to the display control unit 106. In the present embodiment, similar to step S1050 in the first embodiment, the display data generation unit 105 generates two types of display data of the superimposed image in which the invasion candidate region is superimposed on the target image and the index value graph. In this process, the superimposed image and the index value graph both correspond to the display data that is not based on the significance level, at step S1050 in the first embodiment. More specifically, similar to step S1050, in the superimposed image, the display color is applied to the invasion candidate region, but the display color of each pixel is not changed on the basis of the significance level.

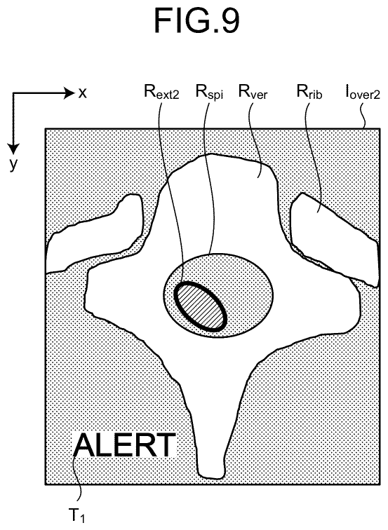

FIG. 9 is a diagram illustrating an example of image data (superimposed image) in which the invasion candidate region extracted at step S2040 is superimposed on the target image, in the second embodiment. In FIG. 9, Iₒᵥₑᵣ₂ represents the superimposed image in the present embodiment. Moreover, Rᵥₑᵣ, R_{rib}, Rₛₚᵢ, and T₁ represent the same as those in FIG. 5A. Furthermore, Rₑₓₜ₂ represents the invasion candidate region to which uniform display color that can be distinguished from the surroundings is applied. In this manner, by allowing the user to confirm the invasion candidate region Rₑₓₜ₂, it is possible to support the user to detect the presence of spinal canal invasion. Still furthermore, in the invasion candidate region Rₑₓₜ₂, compared to the invasion candidate region Rₑₓₜ₁ in FIG. 5A, the side edge part of the spinal canal is not extracted as the region. In this manner, it is apparent that the region excluding the clinically insignificant region is superimposed on the target image as the invasion candidate region Rₑₓₜ₂.

Still furthermore, in the second embodiment, the display data generation unit 105 obtains the index value graph by calculating the ratio of the area of the invasion candidate region Rₑₓₜ₂ with respect to the area of the spinal canal region Rₛₚᵢ as an index value, instead of obtaining the index value graph by weighting the area on the basis of the significance level. Other contents are the same as those at step S1050, and the description will be omitted.

Thus, the processing by the image processing device 200 according to the second embodiment is performed.

According to the second embodiment, when the image processing device 200 extracts the invasion candidate region Rₑₓₜ₂ while taking into account the clinically significant level, the following effects can be obtained. That is, as the extraction result, the image processing device 200 can extract the clinically significant region as the invasion candidate region Rₑₓₜ₂, and remove the noise due to false detection and the clinically insignificant region, from the invasion candidate region Rₑₓₜ₂. Thus, the image processing device 200 can reduce the noise in the spinal canal and the clinically low-risk invasion region from being emphasized, and emphasize the clinically high-risk and significant invasion region.

### First Modification

In the second embodiment, the image processing device 200 generates the display data not based on the significance level, instead of weighting the significance level while extracting the invasion candidate region and removing the noise due to false detection and the clinically insignificant region from the invasion candidate region. However, the image processing device 200 may also generate the display data on the basis of the significance level, in addition to extracting the invasion candidate region. More specifically, the image processing device 200 performs each process at steps S2010 to S2040 in the second embodiment from the start of processing to the extraction of the invasion candidate region, and then performs each process at steps S1040 to S1060 in the first embodiment until the display data is displayed. Consequently, it is possible to remove the noise due to false detection and the clinically insignificant region when the invasion candidate region is extracted, and also reduce the regions from being emphasized when the display data is displayed.

### Second Modification

In the second embodiment, at step S2040, the likelihood of invasion weighted with the significance level is calculated for the likelihood of invasion set for each pixel in the spinal canal region, and the invasion candidate region is extracted as an abnormal region on the basis of the calculated result. However, the invasion candidate region may not necessarily be extracted at step S2040. More specifically, at step S2040, the likelihood of invasion weighted with the significance level may be calculated for each pixel in the spinal canal region, and at step S2050, the display data may be generated using the value. In this case, the image processing device 200 includes a calculation unit instead of the second extraction unit 204. That is, at step S2040, the calculation unit calculates the likelihood of invasion (likelihood of invasion weighted with the significance level) on the basis of the significance level. In this way, the calculation unit calculates the likelihood of abnormal region on the basis of the calculation degree.

Then, at step S2050, as the superimposed image, the display data generation unit 105 can generate the image data in which the likelihood of invasion weighted with the significance level is superimposed on the target image as the luminance information. In this way, the display data generation unit 105 can generate the display data relating to the likelihood of abnormal region. In this process, as described at step S2020 and S2030, if it is assumed that the likelihood of invasion before being weighted and the significance level are both set to values between 0 and 1, the likelihood of invasion weighted with the significance level is also set to a value between 0 and 1. Then, the display data generation unit 105 may change the display color of each pixel in the spinal canal region on the basis of the set value. For example, the display data generation unit 105 makes the color darker with an increase in the weighted value of likelihood of invasion. Moreover, as for the index value graph, for example, a representative value (for example, average value, median value, and the like) of the weighted value of likelihood of invasion for each pixel in the spinal canal region may be calculated for each axial plane of the target image, and use the calculated value as the index value. In this manner, by displaying the information on the likelihood of invasion (likelihood of abnormal region) weighted with the significance level in the spinal canal region as it is, without extracting the invasion candidate region as an abnormal region, the following effects can be obtained. That is, it is possible to present information on the likelihood of invasion relating to the region not picked up as the invasion candidate region by the threshold processing or the like to the user.

### Other Embodiments

Moreover, for example, the technology disclosed in the present specification can take an embodiment as a system, apparatus, method, computer program, or recording medium (storage medium), or the like. Specifically, the technology may be applied to a system composed of a plurality of apparatuses (for example, a server device such as a host computer, an interface device, an imaging device, web applications, and the like), or may be applied to an apparatus composed of a single device.

Needless to say, an object of the technology disclosed in the present specification can be achieved as follows. That is, a recording medium (or storage medium) that records a program code (computer program) of software that implements the functions of the embodiments described above is supplied to the system or apparatus. Needless to say, such a storage medium is a computer-readable storage medium. Then, the computer (or CPU or MPU) of the system or apparatus reads and executes the program code stored in the recording medium. In this case, the program code read from the recording medium implements the functions of the embodiments described above, and the recording medium on which the program code is recorded constitutes the technology disclosed in the present specification.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprising processing circuitry configured to:
extract a spinal canal from a subject region captured in a medical image;
extract an abnormal region in the spinal canal;
set a significance level in the abnormal region, according to a location in the spinal canal; and
generate display data relating to the abnormal region, based on the significance level.

2. The image processing device according to claim 1, wherein the processing circuitry sets the significance level for each of a plurality of pixels representing the abnormal region.

3. The image processing device according to claim 2, wherein the display data is data representing an index value representing a degree of abnormality relating to the abnormal region.

4. The image processing device according to claim 3, wherein the index value is a value relating to a weighted area in the abnormal region, in which the significance level of each of the pixels representing the abnormal region is used as a weight.

5. The image processing device according to claim 4, wherein the index value is a ratio of the weighted area in the abnormal region, with respect to a weighted area in a region of the spinal canal, in which the significance level of each of the pixels representing the region of the spinal canal is used as a weight.

6. The image processing device according to claim 3, wherein the data representing the index value is a graph in which the index value calculated for a cross section intersecting a running direction of a spinal canal in a target image is plotted along the running direction.

7. The image processing device according to claim 1, wherein the display data is image data in which display color of a pixel corresponding to the abnormal region is changed based on the significance level.

8. The image processing device according to claim 1, wherein the significance level is set based on distance from a contour of the spinal canal.

9. The image processing device according to claim 8, wherein the significance level is set higher as the distance from the contour of the spinal canal increases.

10. The image processing device according to claim 1, wherein the processing circuitry extracts the abnormal region based on a difference image between the medical image and a past medical image of the subject.

11. The image processing device according to claim 1, wherein the abnormal region is a region of spinal canal invasion where cancer bone metastasis has invaded the spinal canal.

12. The image processing device according to claim 1, wherein the significance level is a clinically significant level.

13. An image processing device comprising processing circuitry configured to:
extract a spinal canal from a subject region captured in a medical image;
set a clinically significant level in the spinal canal, according to a location in the spinal canal;
extract an abnormal region in the spinal canal based on the significance level; and
generate display data relating to the abnormal region.

14. The image processing device according to claim 13, wherein the processing circuitry sets the significance level for each of a plurality of pixels in the spinal canal.

15. An image processing device comprising processing circuitry configured to:
extract a spinal canal from a subject region captured in a medical image;
set a clinically significant level in the spinal canal, according to a location in the spinal canal;
calculate likelihood of abnormal region in the spinal canal based on the significance level; and
generate display data relating to the likelihood of abnormal region.

16. The image processing device according to claim 15, wherein the processing circuitry sets the significance level for each of a plurality of pixels in the spinal canal.

17. An image processing method comprising:
extracting a spinal canal from a subject region captured in a medical image;
extracting an abnormal region in the spinal canal;
setting a clinically significant level in the abnormal region, according to a location in the spinal canal; and
generating display data relating to the abnormal region, based on the significance level.

18. An image processing method comprising:
extracting a spinal canal from a subject region captured in a medical image;
setting a clinically significant level in the spinal canal, according to a location in the spinal canal;
extracting an abnormal region in the spinal canal based on the significance level; and
generating display data relating to the abnormal region.

19. An image processing method comprising:
extracting a spinal canal from a subject region captured in a medical image;
setting a clinically significant level in the spinal canal, according to a location in the spinal canal;
calculating likelihood of abnormal region in the spinal canal based on the significance level, and
generating display data relating to the likelihood of abnormal region.

20. A computer program that causes a computer to execute:
extracting a spinal canal from a subject region captured in a medical image;
extracting an abnormal region in the spinal canal;
setting a clinically significant level in the abnormal region, according to a location in the spinal canal; and
generating display data relating to the abnormal region, based on the significance level.

21. A computer program that causes a computer to execute:
extracting a spinal canal from a subject region captured in a medical image;
setting a clinically significant level in the spinal canal, according to a location in the spinal canal;
extracting an abnormal region in the spinal canal based on the significance level; and
generating display data relating to the abnormal region.

22. A computer program that causes a computer to execute:
extracting a spinal canal from a subject region captured in a medical image;
setting a clinically significant level in the spinal canal, according to a location in the spinal canal;
calculating likelihood of abnormal region in the spinal canal based on the significance level; and
generating display data relating to the likelihood of abnormal region.
